(19) United States
(12) Patent Application Publication
(10) Pub. No.: US 2011/0211749 A1
(43) Pub. Date: Sep. 1, 2011

(54) System And Method For Processing Video Using Depth Sensor Information

(76) Inventors: Kar Han Tan, Sunnyvale, CA (US); W. Bruce Culbertson, Palo Alto, CA (US)

(21) Appl. No.: 12/714,514

(22) Filed: Feb. 28, 2010

(51) Int. Cl. G06K 9/00

(52) U.S. Cl. 382/154

(57) ABSTRACT

A method for processing video using depth sensor information, comprising the steps of: dividing the image area into a number of bins roughly equal to the depth sensor resolution, with each bin corresponding to a number of adjacent image pixels; adding each depth measurement to the bin representing the portion of the image area to which the depth measurement corresponds; averaging the value of the depth measurement for each bin to determine a single average value for each bin; and applying a threshold to each bin of the registered depth map to produce a threshold image.

### BACKGROUND

Video conferencing in informal settings, for example in mobile or in desktop to desktop environments, is becoming increasingly common. Unlike formal video conference settings which typically have carefully chosen backdrops, informal settings often have visually cluttered or very different backgrounds. These backgrounds can be a distraction that degrades the user experience. It is desirable to replace these undesirable backdrops with a common esthetically pleasing background.

Background subtraction (or foreground segmentation) is the problem of delineating foreground objects in the view of a camera so that the background can be modified, replaced or removed. Some methods for background subtraction use depth data from a depth camera to distinguish between background and foreground. One method uses a two step process, to segregate collected video into foreground and background information. First, a trimap is produced using only data that has a high probability of being background or foreground information. Second, pixels that do not have a high probability of being background or foreground information are filtered using a bilateral filter to generate an estimate of the alpha-matte. Because many of the computations in this process are performed on the high resolution color image domain, the video processing computational load is high and video processing may not run in real time.

A process for providing background subtraction which is computationally efficient to meet the needs of the mobile and desktop settings is needed.

### BRIEF DESCRIPTION OF THE DRAWINGS

The figures depict implementations/embodiments of the invention and not the invention itself. Some embodiments of the invention are described, by way of example, with respect to the following Figures:

FIG. 1 shows a flow diagram of the method of image processing a video image using depth sensor information according to an embodiment of the present invention.

FIG. 2 shows an image of a scene typically captured by an image capture system with depth sensor according to an embodiment of the present invention.

FIG. 3 shows the depth sensor data after registration to the visible image shown in FIG. 2 and after the thresholding step according to one embodiment of the invention.

FIG. 4 shows the image in FIG. 3 after the application of a morphological operation according to an embodiment of the invention.

FIG. 5 shows image of FIG. 4 after the application of a temporal filtering step according to an embodiment of the invention.

FIG. 6 shows the image of FIG. 2 after the temporally filtered matte shown in FIG. 5 is applied to remove the background shown in FIG. 2 according to an embodiment of the invention.

FIG. 7 shows the matte image of FIG. 6 after it is superimposed onto a grayscale image according to an embodiment of the invention.

FIG. 8 shows the matte image of FIG. 5 after application of cross bilateral filtering according to one embodiment of the invention.

FIG. 9 is the image resulting after application of the method for image processing shown in FIG. 1 and described in the present invention.

FIG. 10 is computer system for implementing method according to FIG. 1 in one embodiment of the invention.

### DETAILED DESCRIPTION

We describe an efficient method for processing video that uses a conventional video camera that includes a depth sensor. A depth sensor produces a 2D array of pixels where each pixel corresponds to the distance from the camera to an opaque object in the scene. Depth sensor information can be useful in distinguishing the background from the foreground in images, and thus is useful in background subtraction methods that can be used to remove distracting background from video images.

Current depth sensors do not have the resolution of the image capture sensors. Currently the resolution of depth sensor output is typically at least an order of magnitude lower than those of the image sensor used in a video camera. We take advantage of the low resolution of the depth sensor data and apply many computationally intensive steps in low resolution before applying an efficient bilateral filtering operation in high resolution. The described method produces high quality video with a low computational load.

Current depth cameras include two separate sensors: an image capture sensor and a depth sensor. Because these two sensors are not optically co-located, we need to register the depth data points to the image data points. Although one can perform the registration at the full resolution of the image, this is inefficient because the relatively low number of depth measurements must, in some form, be duplicated across the large number of image pixels. Generating a foreground segmentation from this sparse set of points is possible but is relatively computationally intensive. Instead we choose to perform this registration at the same resolution as the depth map.

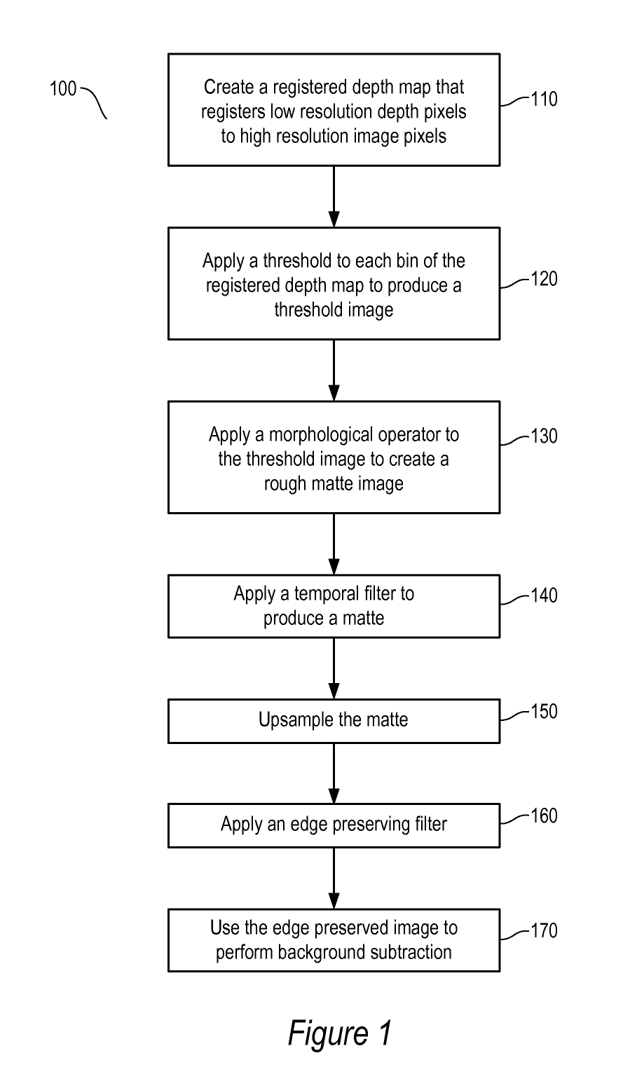

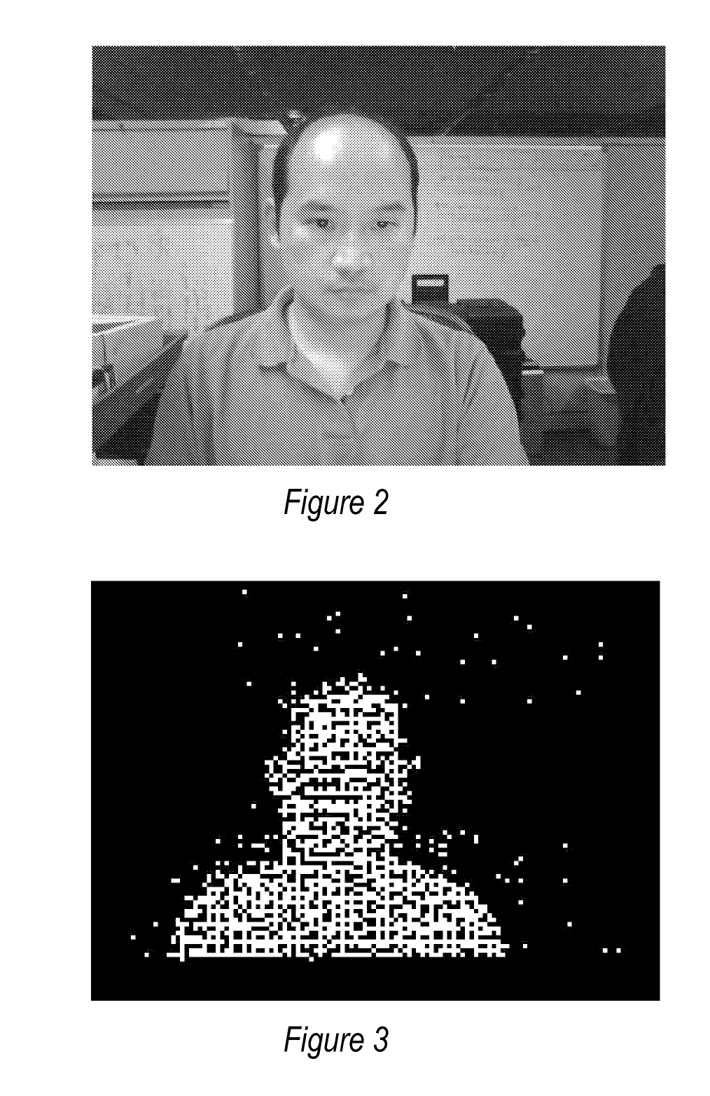

Referring to FIG. 1 shows a flow diagram of the method of image processing a video image using depth sensor information according to an embodiment of the present invention. FIG. 2 shows an example of an image that would captured by an image capture system with depth sensor according to an embodiment of the present invention. According to the present invention, the method of FIG. 1 would be applied to the image of FIG. 2 in one embodiment, to produce the resultant images shown in FIGS. 3-9.

Referring to FIG. 1 includes the steps of: creating a registered depth map that registers depth pixels in a depth coordinate system to image pixels in an image coordinate system; and applying a threshold to each bin of the registered depth map to produce a threshold image. Referring to FIG. 1 shows the step of creating a registered depth map that registers the low resolution depth pixels to the high resolution color image pixels (step 110). In the embodiment described in the present invention, the registered depth map is created according to the following steps: mapping each depth pixel from the depth sensor coordinate system to the image coordinate system, dividing the image area into a number of bins roughly equal to the depth sensor resolution, with each bin corresponding to a number of adjacent image pixels; and adding each depth measurement to the bin representing the portion of the image area to which the depth measurement corresponds. After all of the depth measurements are binned, each bin contains zero, one or several depth measurement corresponding to that portion of the image area. For each depth pixel bin, the average depth value is computed for that bin.

Both image sensor data and depth sensor data are captured by the video. As previously stated because the two sensors are not co-located, we are essentially capturing data from two different points and thus two different coordinate systems. Each image pixel captured corresponds to a pixel in an image coordinate system. Similarly, each depth pixel captured corresponds to a pixel in a depth coordinate system. Because the depth resolution is lower than the image resolution, each depth measurement corresponds to a number of image pixels. A depth measurement is roughly the average of all of the depth values of all of the corresponding image pixels. A first step in creating a registered depth map is to map each depth pixel from the depth pixel coordinate system to an image pixel in the image coordinate system.

Mapping ensures that when we talk about a point in the video—we are referring to the same point (this image pixel that has a corresponding depth pixel on the same coordinate system). In one embodiment, we take depth sensor data and map it into the coordinate space of the RGB image. Camera calibration allows us to determine how the geometry of the depth sensor and image camera are related. The calibration, plus the depth recorded for a depth pixel, allows us to identify the 3D point in the scene corresponding to the depth pixel. The calibration then allows us to map the 3D point into an image pixel. It is through this process that the depth pixels are mapped to image pixels.

Another difference between depth sensor and image sensor data (besides the original coordinate systems) is resolution. Currently, the resolution in depth sensors has not reached the resolution levels available in video camera systems. For example, a depth camera typically has a resolution on the order of 160×120 pixels while the resolution of an RGB image captured by video is typically on the order of 1024×768 pixels. This is unfortunate, since ideally we would like to know the depth at every pixel. Instead a block of RGB pixels is associated with a depth pixel.

We map the depth pixels to the RGB image by coordinate transformation. Because this is computationally more expensive to perform computations in high resolution, we choose to remain in the lower resolution domain of the depth sensor. To do this, we divide the image into a number of bins such that the bins have the resolution of the depth sensor and each bin corresponds to a number of adjacent image pixels. Because the resolution of the depth sensor is typically less than the resolution of the RGB image sensor, a single depth pixel will typically correspond to a block of image pixels. The grouping will typically be related to the binning groups chosen.

Typically, the last step in the creation of the registered depth map is computing a single average depth value for the depth values found in each bin. Depending on the mapping, the number of pixel values associated with a particular bin varies. In one embodiment, the value of the pixel is computed by finding the average depth value for the pixels in each bin. In the case where there is just one depth pixel, the average is just the value of that single depth value.

After the registered depth map is created, a threshold value is applied to the single computed depth value in the bin (step 120). The threshold is used to determine which depth values in the image are in the foreground and which depth values are in the background. In one embodiment, a value of 1 is assigned if the depth value is below the threshold and a value of zero is assigned if the depth value is equal to or greater than the threshold value. After the step of creating a registered depth map for the image shown in FIG. 2 and applying the threshold to each bin, results in the low resolution thresholded image shown in FIG. 3.

In one embodiment, the threshold is manually set. For example, if it is known that the person in the video is sitting in front of a desktop computer screen in a video conference, the threshold might be determined and manually set based on a likely distance that a person would be sitting from the computer screen. Alternatively, the threshold value might be automatically determined using face detection or histogram analysis. For a video conferencing system, detection of a face would indicate that the face of the person would be the depth of the foreground. Similarly, for a desktop to desktop video conference, using a histogram should lead to a distribution of peaks-one peak for where the person is sitting (the foreground), the other for indicating the background location.

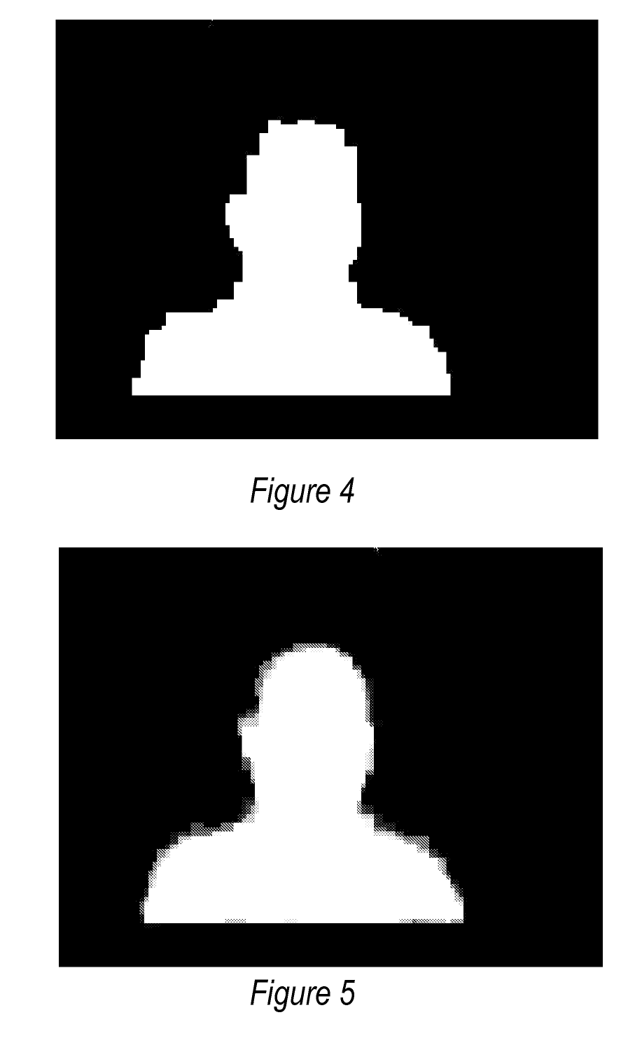

After the thresholding step, a denoising operator is applied. In one embodiment, the denoising operator is a sequence of one or more morphological operators that is applied to the thresholded image to produce the coarse matte (step 130) shown in FIG. 4. As shown in FIG. 3, the thresholded image result is an extremely noisy binary mask. Morphological operators are used to minimize the noise, producing the result shown in FIG. 4. It is important to note that we can do this efficiently because we are operating in low resolution.

After application of the morphological operation, a temporal filter is applied (step 140). Temporal filtering is used primarily to minimize flickering along the boundary between the foreground and background. In one embodiment, and as shown by the function below—a temporal exponential filter is applied for each time step t. For this embodiment, the function describing the filtering is:

Matte(t)=beta×coarse matte(t)+(1−beta)×matte(t−1).

Matte can generally be thought of as a reflection of the confidence level as to whether a pixel is in the foreground or background. Beta is some value between 0 and 1. The value of beta can be varied to control the amount of temporal filtering, possibly based on observed motion. In one embodiment, temporal filtering is applied adaptively, using a small window when the matte is changing rapidly and using a long window when the matte is stationary. This reduces the appearance of latency between the matte and the RGB image while producing pleasing, low flicker (or flicker free) mattes.

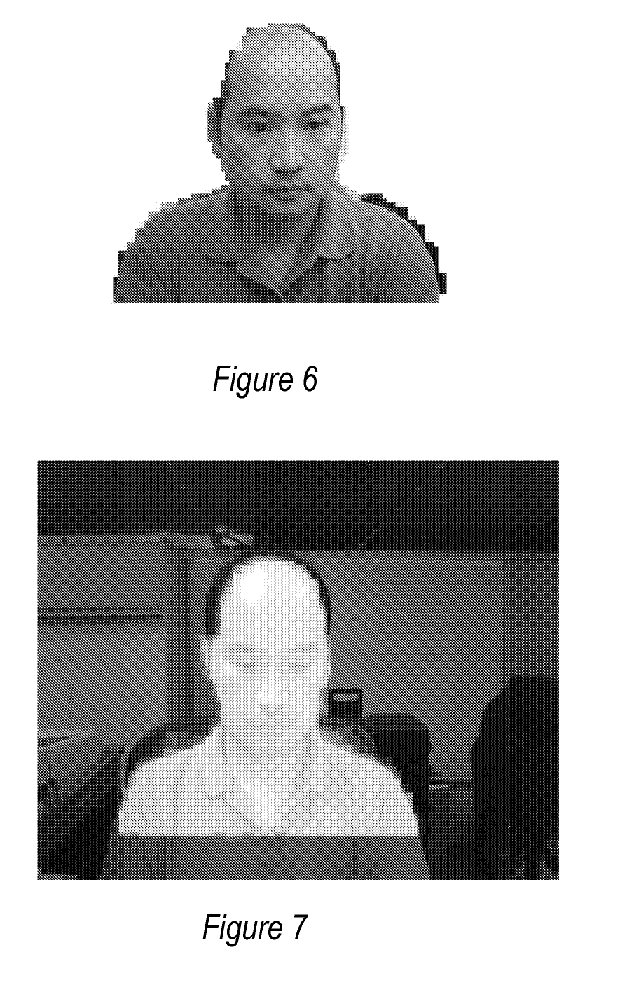

Applying exponential temporal filtering results in the matte shown in FIG. 5. FIG. 6 shows the image of FIG. 2 after the temporally filtered matte shown in FIG. 5 is applied to remove the background shown in FIG. 2. Although this temporally filtered matte can be used for background subtraction, it produces jagged boundaries as is shown in FIG. 6. Optionally, the matte shown in FIG. 6 can be additionally enhanced by applying additional image processing such as face detection or hair color detection to improve the results.

After application of the temporal features (and application of optional enhancements), the temporally filtered matte is upsampled (step 150). When we upsample the temporally filtered matte, the resultant image has the same resolution as the high resolution image. Although in theory upsampling could occur at an earlier point in the process described in FIG. 1, (for example after the threshold step 120, the morphological operation step 130, the temporal filter step 140), applying the upsampling step would make the process less efficient computationally.

Although various upsampling methods exist, in one embodiment nearest neighbor upsampling is used. FIG. 7 shows the upsampled matte superimposed on a high resolution image.

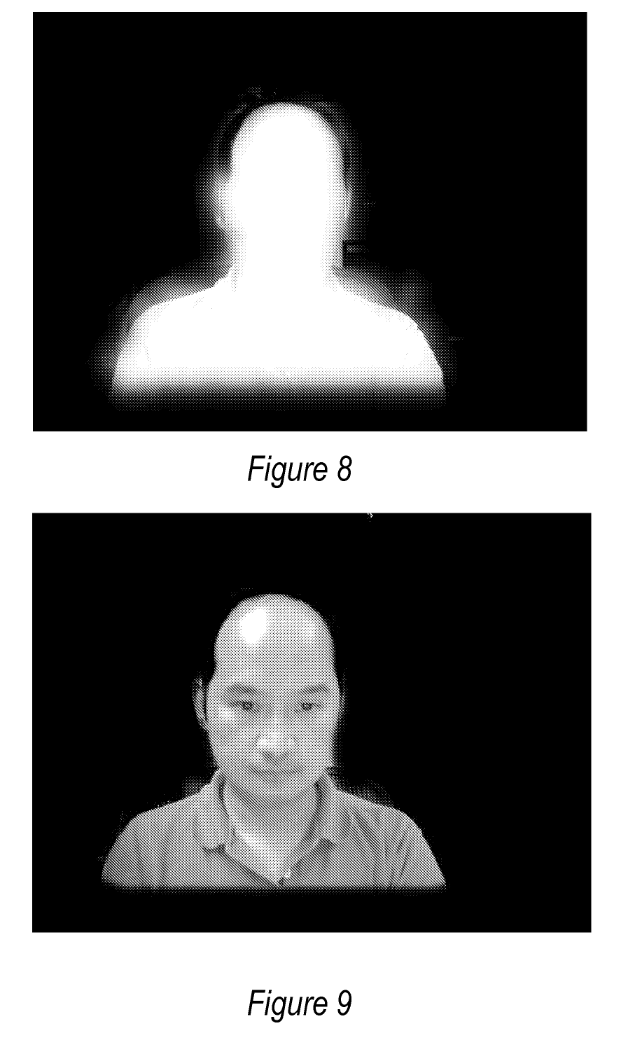

After upsampling the matte, an edge preserving filter is applied (step 160). Filtering removes the jagged edges that can be seen in the matte shown in FIG. 6. The edge preserving feature of the new filter forces the new smoother edge to follow the foreground/background edge that is visible in the image shown in FIG. 2. In one embodiment, the edge preserving filter is a cross bilateral filter. The cross bilateral filter is applied using the intensity image as the range image. This produces the high quality matte image shown in FIG. 8. The edge preserved matte image shown in FIG. 8 can be used to perform background subtraction (step 170). Performing background subtraction using this image results in the image shown in FIG. 9.

Some or all of the operations set forth in the method shown in FIG. 1 may be contained as a utility, program or subprogram, in any desired computer accessible medium. In addition, the method 100 may be embodied by a computer program, which may exist in a variety of forms both active and inactive. For example, it exist as software program(s) comprised of programs instructions in source code, object code, executable code or other formats. Certain processes and operation of various embodiments of the present invention are realized, in one embodiment, as a series of instructions (e.g. software program) that reside within computer readable storage memory of a computer system and are executed by the processor of the computer system. When executed, the instructions cause the computer system to implement the functionality of the various embodiments of the present invention. Any of the above can be embodied on a computer readable medium, which include storage devices and signals, in compressed or uncompressed form.

The computer readable storage medium can be any kind of memory that instructions can be stored on. Examples of the computer readable storage medium include but are not limited to a disk, a compact disk (CD), a digital versatile device (DVD), read only memory (ROM), flash, and so on. Exemplary computer readable storage signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore understood that any electronic device capable of executing the above-described functions may perform those functions enumerated above.

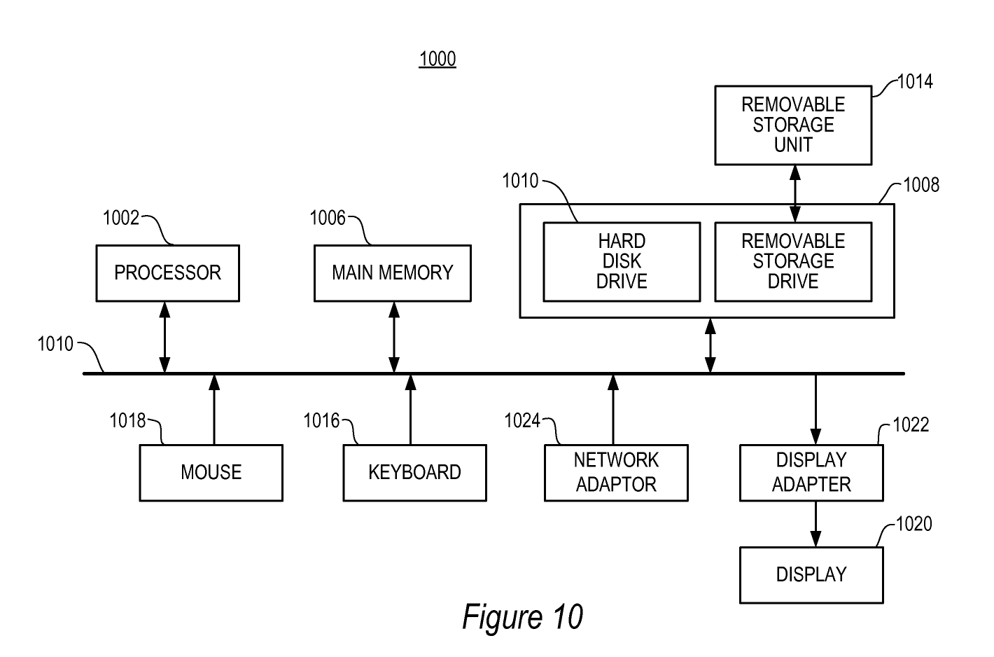

FIG. 10 illustrates a computer system, which may be employed to perform various functions described herein, according to one embodiment of the present invention. FIG. 10 illustrates a computer system 1000, which may be employed to perform various functions of the asset location system, described herein above, according to an example. In this respect, the computer system 1000 may be used as a platform for executing one or more of the functions described hereinabove.

The computer system 1000 includes a microprocessor 1002 that may be used to execute some or all of the steps described in the methods shown in FIG. 1. Commands and data from the processor 1002 are communicated over a communication bus 1004. The computer system 1000 also includes a main memory 1006, a secondary memory, such as a random access memory (RAM), where the program code for, for instance, may be executed during runtime. The secondary memory 1008 includes for example, one or more hard disk drives 1010 and/or a removable storage drive 1012, representing a floppy diskette drive, a magnetic tape drive, a compact disk drive, etc., where a copy of the program code for tracking tags may be stored.

The removable storage drive 1010 may read from and/or write to a removable storage unit 1014. User input and output devices may include, for instance, a keyboard 1016, a mouse 1018, and a display 1020. A display adaptor 1022 may interface with the communication bus 1004 and the display 1020 and may receive display data from the processor 1002 and covert the display data into display commands for the display 1020. In addition, the processor 1002 may communicate over a network, for instance, the Internet, LAN, etc. through a network adaptor. The embodiment shown in FIG. 10 is for purposes of illustration. It will be apparent to one of ordinary skill in the art that other know electronic components may be added or substituted in the computer system 1000.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. For example, if an image capture sensor had depth and image sensor, co-located, the coordinate transformation steps would not be required for this invention. In this case, a method for processing video comprised of both image and depth sensor information, would comprise the steps of: dividing the image area into a number of bins roughly equal to the depth sensor resolution, with each bin corresponding to a number of adjacent image pixels; adding each depth measurement to the bin representing the portion of the image area to which the depth measurement corresponds; averaging the value of the depth measurement for each bin to determine a single average value for each bin; and applying a threshold to each bin to produce a threshold image.

The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method executed on a computer, for processing a video using depth sensor information comprising the steps of
creating a registered depth map that registers depth pixels in a depth coordinate system to image pixels in an image coordinate system,
wherein the registered depth map is created from video image information comprised of depth pixels corresponding to a depth coordinate system and image pixels corresponding to an image coordinate system, wherein the image coordinate system is divided into a number of bins such that each image pixel location is represented with a resolution comparable to the depth sensor; and
applying a threshold to each bin of the registered depth map to produce a threshold image.

2. The method recited in claim 1 wherein creating a registered depth map includes the steps of: mapping each depth pixel from the depth coordinate system to an image coordinate system, dividing the image area into a number of bins roughly equal to the depth sensor resolution, with each bin corresponding to a number of adjacent image pixels; and adding each depth measurement to the bin representing the portion of the image area to which the depth measurement corresponds.

3. The method recited in step 2 wherein the step of creating a registered depth map further includes the step of: for each bin, computing the average depth measurement value for that bin.

4. The method recited in claim 1 further including the step of applying a morphological operator to the threshold image to create a rough matte image.

5. The method recited in claim 4 further including the step of applying a morphological operator to the thresholded image to create a rough matte.

6. The method recited in claim 5 further including the step of applying a temporal filter to produce a temporally filtered matte.

7. The method recited in claim 6 wherein the temporal filter is an exponential filter.

8. The method recited in claim 7 further including the step of applying a further image enhancing technique to produce an enhanced temporally filtered matte, wherein the image enhancing techniques are directed towards reducing the jaggedness of the boundary between the foreground and the background.

9. The method recited in claim 8 wherein the image enhancing technique uses face detection.

10. The method recited in claim 9 wherein the image enhancing technique uses hair color detection.

11. The method recited in claim 8 further including the step of upsampling the enhanced temporally filtered matte to create an upsampled matte.

12. The method recited in claim 6 further including the step of upsampling the temporally filtered matte to create an upsampled matte.

13. The method recited in claim 11 further including the step of applying an edge preserving filter to produce an edge preserved matte.

14. The method recited in claim 13 wherein the edge preserving filter is a cross bilateral filter.

15. The method recited in claim 14 further including the step of using the edge preserved matte to perform background subtraction.

16. A tangible computer readable storage medium having instructions for causing a computer to execute a method comprising the steps of:
creating a registered depth map that registers depth pixels in a depth coordinate system to image pixels in an image coordinate system,
wherein the registered depth map is created from video information comprised of depth pixels corresponding to a depth pixel coordinate system and image pixels corresponding to an image coordinate system, wherein the image coordinate system is divided into a number of bins such that each image pixel location is represented with a resolution comparable to the depth sensor; and
applying a threshold to each bin of the registered depth map to produce a threshold image.

17. A method, executed on a computer, for processing a video image comprised of both image and depth sensor information, comprising the steps of:
dividing the image area into a number of bins roughly equal to the depth sensor resolution, with each bin corresponding to a number of adjacent image pixels;
adding each depth measurement to the bin representing the portion of the image area to which the depth measurement corresponds;
averaging the value of the depth measurement for each bin to determine a single average value for each bin; and
applying a threshold to each bin to produce a threshold image.

18. The method recited in claim 17 further including the step of applying a morphological operator to the thresholded image to create a rough matte.

19. The method recited in claim 18 further including the step of applying a temporal filter to produce a temporally filtered matte.

20. The method recited in claim 19 further including the step of upsampling the enhanced temporally filtered matte to create an upsampled matte.
